(19) United States
(12) Patent Application Publication
(10) Pub. No.: US 2025/0384494 A1
(43) Pub. Date: Dec. 18, 2025

(54) SOCIAL STATUS POSTING METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Yaohua YUE, Shenzhen (CN); Chenguang YANG, Shenzhen (CN); Yasu WU, Shenzhen (CN); Ziyun LIU, Shenzhen (CN); Junjiang NIE, Shenzhen (CN); Huifu JIANG, Shenzhen (CN); Qiming ZHU, Shenzhen (CN)

(21) Appl. No.: 19/285,963

(22) Filed: Sep. 3, 2025

Related U.S. Application Data
(63) Continuation of application No. PCT/CN2024/086936, filed on Apr. 10, 2024.

(30) Foreign Application Priority Data
Jun. 29, 2023 (CN) 202310788532.5

(51) Int. Cl. G06Q 50/00; G06T 13/40; G06T 19/20

(52) U.S. Cl. CPC G06Q 50/01; G06T 13/40; G06T 19/20; G06T 2219/2004

(57) ABSTRACT

A social status posting method performed by a client running on a computer device and logged in using a first user account. The social status posting method includes: displaying a first social status posted by the first user account, a posting location of the first social status being a first location; and displaying, when a positioning location of the client moves from an outside of a geographical area including a first location into the geographical area, a second social status automatically posted by the client, status information of the second social status being determined based on status information of the first social status

### CROSS-REFERENCES TO RELATED APPLICATIONS

This application is a continuation application of PCT Patent Application No. PCT/CN2024/086936, filed on Apr. 10, 2024, which claims priority to Chinese Patent Application No. 2023107885325, filed on Jun. 29, 2023, all of which is incorporated herein by reference in their entirety.

### FIELD OF THE TECHNOLOGY

The present disclosure relates to the field of human-computer interaction, and in particular, to a social status posting method and apparatus, and a device and a storage device.

### BACKGROUND OF THE DISCLOSURE

In social applications, users may record their lives by posting their social status updates. For example, a user may post a workout status during exercising to record the workout session. At this point, the social status is a workout status. Similarly, during a gathering, the user can post a party status to capture interesting moments from the event. Here, the social status is a party status.

In related technologies, the user may select a status type, edit status text, and add a status picture on a status posting page of the social application, and post the social status after editing.

However, when the user wants to record daily life by posting the social status, the user needs to manually post a plurality of social statuses every day, resulting in low efficiency of the human-computer interaction.

### SUMMARY

One embodiment of the present disclosure provides a social status posting method. The method is performed by a client running on a computer device and logged in using a first user account. The method includes: displaying a first social status posted by the first user account, a posting location of the first social status being a first location; and displaying, when a positioning location of the client moves from an outside of a geographical area including a first location into the geographical area, a second social status automatically posted by the client, status information of the second social status being determined based on status information of the first social status.

Another embodiment of the present disclosure provides a computer device. The computer device includes one or more processors and a memory containing at least one instruction, at least one segment of program, a code set, or an instruction set that, when being executed, causes the one or more processors to perform: displaying a first social status posted by the first user account, a posting location of the first social status being a first location; and displaying, when a positioning location of the client moves from an outside of a geographical area including a first location into the geographical area, a second social status automatically posted by the client, status information of the second social status being determined based on status information of the first social status.

Another embodiment of the present disclosure provides a non-transitory computer-readable storage medium containing at least one instruction, at least one segment of program, a code set, or an instruction set that, when being executed, causes at least one processor to perform displaying a first social status posted by the first user account, a posting location of the first social status being a first location; and displaying, when a positioning location of the client moves from an outside of a geographical area including a first location into the geographical area, a second social status automatically posted by the client, status information of the second social status being determined based on status information of the first social status.

Details of one or more embodiments of the present disclosure are provided in the accompanying drawings and descriptions below. Other features, objectives, and advantages of the present disclosure become apparent from the specification, the drawings, and the claims.

### BRIEF DESCRIPTION OF THE DRAWINGS

To describe technical solutions in embodiments of the present disclosure or in a conventional technology more clearly, the following briefly describes the drawings required for describing the embodiments or the conventional technology. Apparently, the drawings in the following descriptions show merely embodiments of the present disclosure, and a person of ordinary skill in the art may further obtain other drawings according to the disclosed drawings without creative efforts.

FIG. 1 is a block diagram of a computer system according to an exemplary embodiment of the present disclosure.

FIG. 2 is a schematic diagram of a user interface for a social status posting method according to an exemplary embodiment of the present disclosure.

FIG. 3 is a schematic diagram of a user interface for a social status posting method according to an exemplary embodiment of the present disclosure.

FIG. 4 is a schematic diagram of a user interface according to another exemplary embodiment of the present disclosure.

FIG. 5 is a schematic diagram of a user interface for a social status posting method according to an exemplary embodiment of the present disclosure.

FIG. 6 is a schematic diagram of a user interface for a social status posting method according to an exemplary embodiment of the present disclosure.

FIG. 7 is a schematic diagram of a user interface according to another exemplary embodiment of the present disclosure.

FIG. 8 is a schematic diagram of a user interface for a social status posting method according to an exemplary embodiment of the present disclosure.

FIG. 9 is a flowchart of a social status posting method according to an exemplary embodiment of the present disclosure.

FIG. 10 is a flowchart of a social status posting method according to an exemplary embodiment of the present disclosure.

FIG. 11 is a flowchart of a social status posting method according to an exemplary embodiment of the present disclosure.

FIG. 12 is a flowchart of a social status posting method according to an exemplary embodiment of the present disclosure.

FIG. 13 is a schematic diagram of a user interface for a social status posting method according to an exemplary embodiment of the present disclosure.

FIG. 14 is a schematic diagram of a social status posting method according to an exemplary embodiment of the present disclosure.

FIG. 15 is a flowchart of a social status posting method according to an exemplary embodiment of the present disclosure.

FIG. 16 is a flowchart of a social status posting method according to an exemplary embodiment of the present disclosure.

FIG. 17 is a flowchart of a social status posting method according to an exemplary embodiment of the present disclosure.

FIG. 18 is a flowchart of a social status posting method according to an exemplary embodiment of the present disclosure.

FIG. 19 is a flowchart of a social status posting method according to an exemplary embodiment of the present disclosure.

FIG. 20 is a block diagram of a social status posting apparatus according to an exemplary embodiment of the present disclosure.

FIG. 21 is a block diagram of a terminal according to an exemplary embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

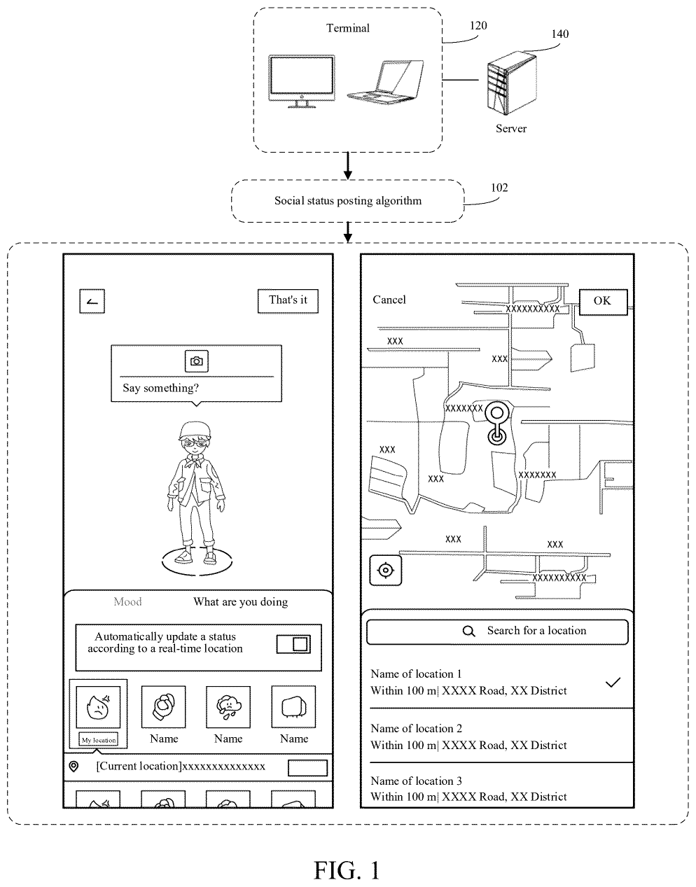

FIG. 1 is a schematic diagram of a computer system according to an exemplary embodiment of the present disclosure. The computer system includes a terminal and a server.

The terminal 120 may include at least one of a smartphone, a notebook computer, a desktop computer, a tablet computer, or a smart robot. In an exemplary embodiment, the social status posting method according to the present disclosure may be applied to a map-based social application.

The map-based social application supports a social status posting function. The application may be: an instant messaging program, a social application, a browser application, a live streaming application, a video playing program, a short video playing program, an information program, a knowledge-type program, a life-type program, a shopping-type program, a picture sharing program, a community program, a forum application, an office application, or the like. In some embodiments, the terminal 120 is installed with a client of the application.

For example, the terminal 120 stores a social status posting algorithm 102. When the client needs to use the social status posting function, the client may invoke the social status posting algorithm to complete social status posting.

The terminal 120 includes a first memory and a first processor. The first memory stores the social status posting algorithm. The social status posting algorithm is invoked and executed by the first processor to implement the social status posting method according to the present disclosure. The first memory may include, but is not limited to, the following: a random access memory (RAM), a read only memory (ROM), a programmable read-only memory (PROM), an erasable programmable read-only memory (EPROM), and an electrically erasable programmable read-only memory (EEPROM).

The first processor may be formed by one or more integrated circuit chips. In some embodiments, the first processor may be a general purpose processor, for example, a central processing unit (CPU), or a network processor (NP). In some embodiments, the first processor may implement, by running a program or code, the social status posting method according to the present disclosure.

The terminal 120 and the server 140 are connected to each other by a wired or wireless network.

The server 140 is configured to provide a back-end service to a client of an application in the terminal 120. For example, the server 140 may be a back-end server 140 of the application. The server 140 may be one server 140, a cluster of servers 140 formed by a plurality of servers 140, or a cloud computing service center.

For example, the server 140 includes a processor and a memory, where the memory further includes an access module and an information stream pushing module. The server 140 is configured to provide a back-end service to the map-based social application. In some embodiments, the server 140 is responsible for primary computing work, and the terminal 120 is responsible for secondary computing work; or, the server 140 is responsible for secondary computing work, and the terminal 120 is responsible for primary computing work; or, the server 140 and the terminal 120 perform collaborative computing by using a distributed computing architecture.

The server 140 includes a second memory and a second processor. The second memory stores the social status posting algorithm. The social status posting algorithm is invoked and executed by the second processor to implement the social status posting method according to the present disclosure. In some embodiments, the second memory may include, but is not limited to, the following: a RAM, a ROM, a PROM, an EPROM, and an EEPROM. In some embodiments, the second processor may be a general-purpose processor, for example, a CPU or an NP.

For example, an application using the social status posting method according to this embodiment of the present disclosure is provided. The application supports the following functions.

### 1. Location-Based Social Status Posting

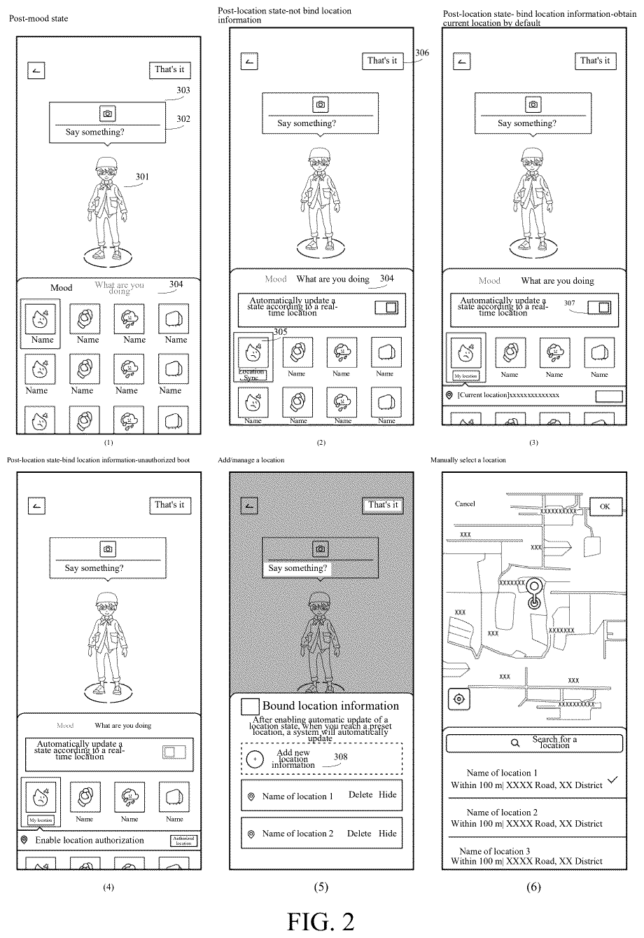

A status posting page of the application is shown in (1) in FIG. 2. A virtual character (which may be a three-dimensional virtual character) 301 of a first user account, a status text editing area 302, a status picture adding area 303, and a status selection area 304 are displayed on the status posting page. In the status selection area, a user may select to post a mood status or a location-based location status, and in this case, both the mood status and the location-based location status are social statuses.

If the user wants to post the location status, a location status posting control (a jump control “what are you doing” in the figure) is selected, a status posting page shown in (2) in FIG. 2 is displayed, a plurality of types of location statuss are provided in the status selection area 304 in (2) in FIG. 2, and the user may select a location status from the plurality of types of location statuss for posting. For example, the user selects a first location status 305.

For example, the location status may be posted when a location is not bound. For example, in the status posting page shown in (1) in FIG. 2, after selecting the first location status 305, the user may not select a location, but directly click a posting control 306 to post a social status.

If the user wants to post a binding location, a synchronization location control corresponding to the first location status 305 may be clicked to jump to the status posting page shown in (3) in FIG. 2. A client automatically binds a positioning location to the first location status 305 as a posting location.

When the user does not authorize the client to obtain location information, the status posting page shown in (4) in FIG. 2 is displayed. Location authorization guidance information is displayed on the status posting page, and the user may authorize, according to the authorization guidance information, the client to obtain the location information. After location authorization is obtained, the status posting page shown in (3) in FIG. 2 is displayed.

In some embodiments, as shown in (3) in FIG. 2, an automatic posting switch 307 is further displayed on the status posting page. If the user turns on the automatic posting switch 307, after the user posts the location status, automatic posting of the social status is triggered when the client arrives at the location again. After the automatic posting switch is turned on, a location management page shown in (5) in FIG. 2 may be displayed, to manage a location bound to the location status. The bound location is configured for triggering automatic posting of a social status. The user may add or delete the location bound to the location status on the location management page. For example, one location status may be bound to at least one location. For example, the user may trigger a location adding control 308 to jump to a location selection page shown in (6) in FIG. 2, to select a location to add.

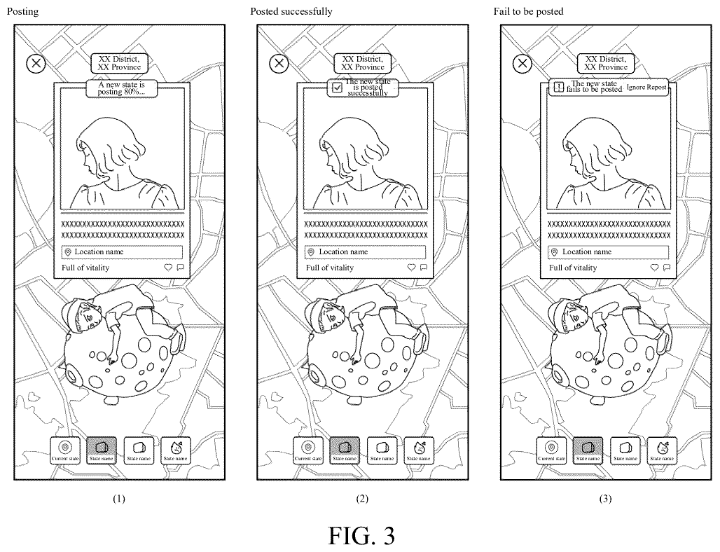

For example, after editing the location status, the user may post the location status. During posting, the client displays a page shown in (1) in FIG. 3, and displays an uploading progress of the location status. Detailed information (text, a picture, a location, a like control, and a comment control) about the location status is displayed on a map image in an overlapping mode. A virtual character of the first user account is further displayed at the posting location of the location status, and the virtual character may be displayed as an action corresponding to the location status.

If the location status is successfully posted, a page shown in (2) in FIG. 3 is displayed, and prompt information indicating that a new status is posted successfully is displayed. If the location status fails to be posted, a page shown in (3) in FIG. 3 is displayed, prompt information indicating that the new status fails to be posted is displayed, and an ignore control and a resending control are displayed.

### 2. Location-Based Social Status Viewing

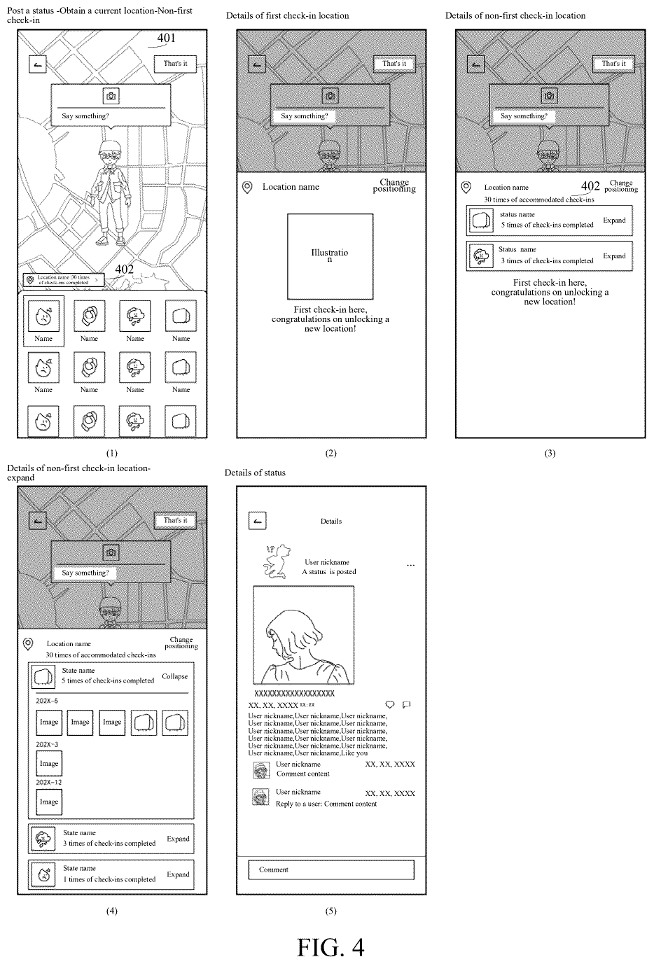

A user interface of the application is shown in (1) in FIG. 4. A map image 401 is displayed. The map image may be a geographic map (which may be one of a road map, a city map, a natural map, a digital map, an image map, a satellite map, and an electronic map) of a positioning location of the client. The virtual character of the first user account is further displayed at the positioning location of the map image. The map image is further marked with a name 402 of the positioning location, and displays a number of check-ins of the positioning location. If the user triggers the positioning location (for example, clicks the virtual character or the name 402), a location-based social status viewing page is jumped to. When the user does not check in at this location, a first check-in location prompt page shown in (2) in FIG. 4 may be displayed. When the user checked in at the location previously, a social status list shown in (3) in FIG. 4 may be displayed. The social status list displays at least two statuss types of check-ins of the first user account at the location, and a number of check-ins corresponding to each status type. If the user clicks an expansion control of one of the status types, a page shown in (4) in FIG. 4 may be displayed, and a plurality of social statuses of the status type are displayed on the page. The plurality of social statuses are sorted in reverse order of a posting time. If the user selects one of the social statuses, a presentation page of a social status shown in (5) in FIG. 4 may be jumped to. Detailed information of the social status, for example, text, a picture, a posting time, a posting location, like information, or comment information of the social status, is displayed on the presentation page of the social status.

### 3. Shortcut View of a Social Status Posted in One Day

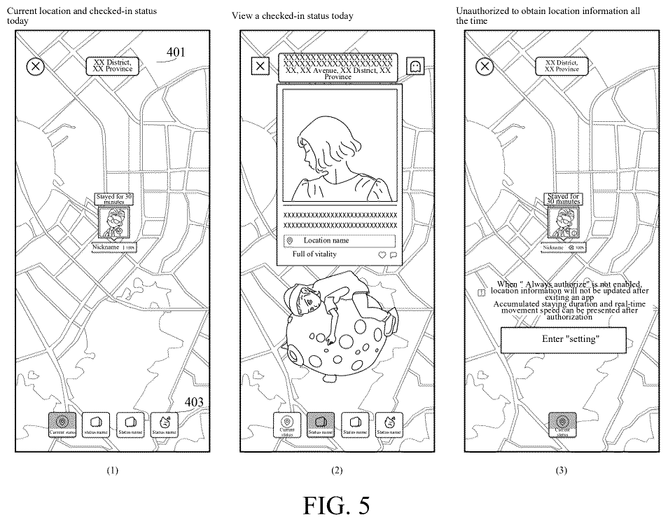

Another user interface of the application is shown in (1) in FIG. 5. A map image 401 is displayed. Account information of a first user account is displayed at the positioning location of the client in the map image 401. The account information includes a profile photo, a nickname, an amount of electricity, and duration of the first user account staying at the positioning location. A social status (a jump control 403 corresponding to the social status) posted by the first user account today is displayed below the map image 401. For example, if the first user account has posted three social statuses today (00:00-24:00), jump controls respectively corresponding to the three social statuses are displayed.

If the user triggers a jump control of a social status, for example, selects a jump control of a second social status, the map image is quickly jumped to a posting location corresponding to the second social status, and an image shown in (2) in FIG. 5 is displayed. The image displays detailed information of the second social status and a virtual character located at the posting location of the second social status.

In some embodiments, if the user does not authorize the client to obtain a terminal location, a page shown in (3) in FIG. 5 is displayed, prompt information indicating that position authorization is not obtained is displayed, and a guide authorization prompt is displayed.

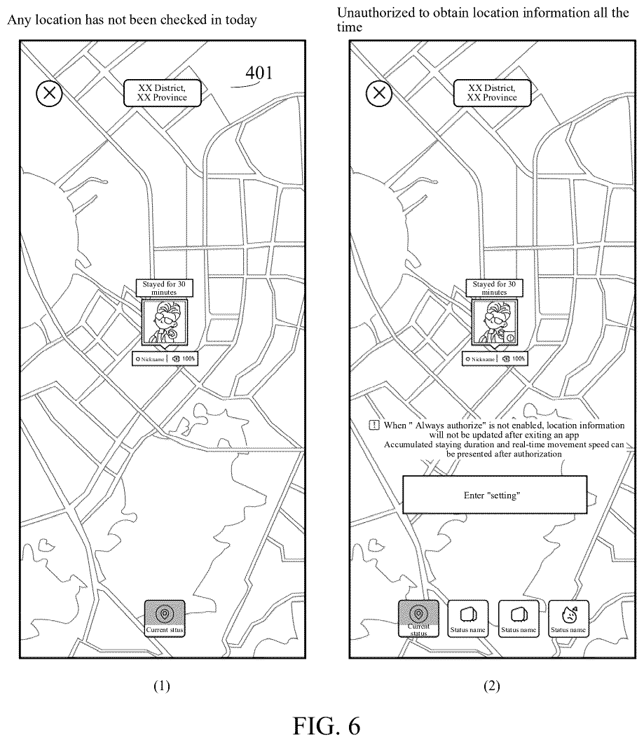

If the first user account has not posted a social status today, an image shown in (1) in FIG. 6 is displayed, and account information of the first user account is displayed only at the positioning location of the map image 401. Similarly, if the user does not authorize the client to obtain the terminal location, a page shown in (2) in FIG. 6 is displayed, prompt information indicating that location authorization is not obtained is displayed, and a guide authorization prompt is displayed.

### 4. View of a Social Status of a Friend

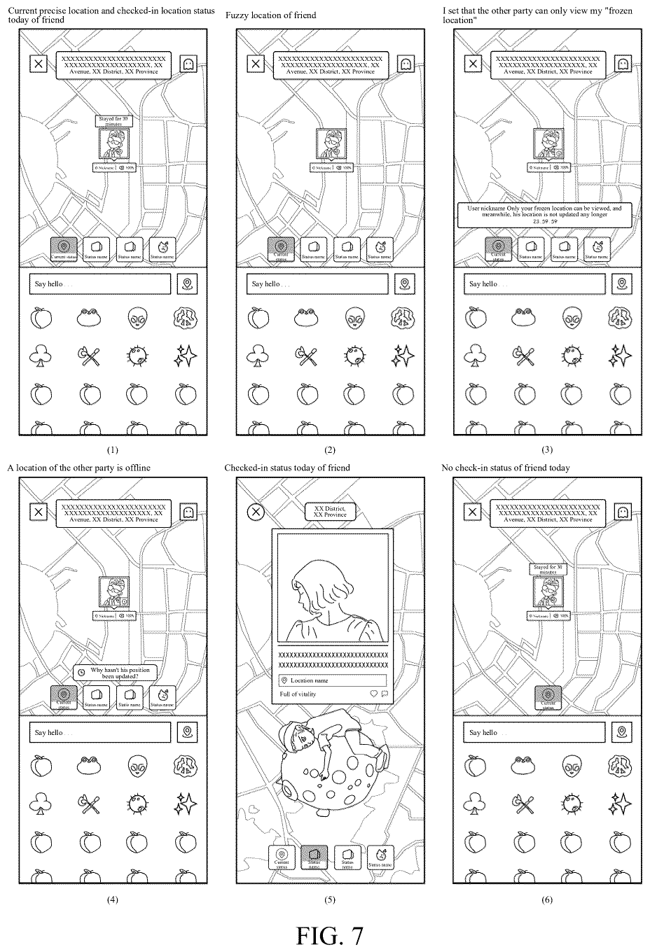

The user may further view a social status of a friend in an application. As shown in (1) in FIG. 7, a positioning location of a friend account (the second user account) is further displayed on the map image. The account information of the friend account is displayed at the positioning location of the friend account. The user may trigger the friend account to display, on the map image, a jump control indicating a social status posted by the friend account today.

If precise positioning of the friend account is not enabled, a page shown in (2) in FIG. 7 is displayed. If the first user account sets that the friend account can only view a frozen location, a page shown in (3) in FIG. 7 is displayed, to prompt that a location of the friend account is not updated when it is set that the friend can only view the frozen location of the friend. If the friend account is offline, a page shown in (4) in FIG. 7 is displayed, to prompt that the friend is offline.

If the user triggers a jump control of a social status of the friend, a page shown in (5) in FIG. 7 is displayed, and a presentation page of the social status is displayed. For example, a background map of the presentation page is a screenshot of a map image displayed on the client of the friend when the friend account posts the social status.

If the friend account does not post a social status today, a page shown in (6) in FIG. 7 is displayed, and the jump control is not displayed on the page.

### 5. View of a Social Status Based on a Calendar

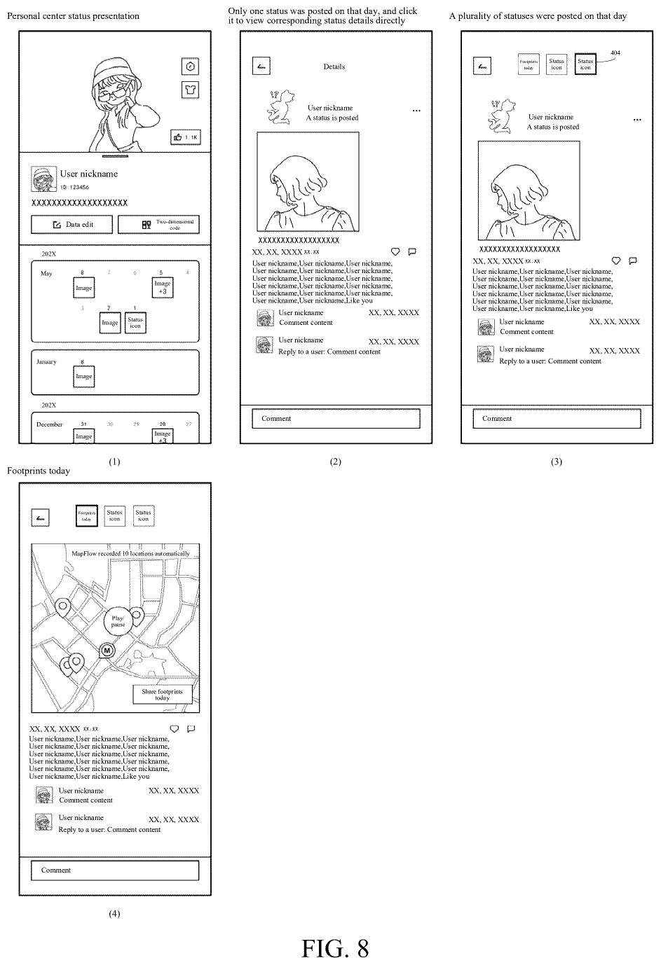

The application may further display, in a form of a calendar, all social statuses posted by a user account on a personal center page of the user account. For example, as shown in (1) in FIG. 8, a personal center page of the first user account is displayed. The personal center page displays all posting dates when the first user account has posted the social statuses, and these posting dates are sorted in reverse order of time. The personal center page further displays a virtual character, a nickname, an account identifier, a personalized signature, a two-dimensional code, data information, and the like of the first user account.

If the user triggers a posting date (the posting date may be a day, a week, or a period of time within a day) on the personal center page, a status presentation page on the posting date is displayed. When only one social status has been posted on the posting date, a status presentation page shown in (2) in FIG. 8 is displayed, and detailed information about the social status is displayed on the status presentation page. When at least two social statuses have been posted on the posting date, a status presentation page shown in (3) in FIG. 8 is displayed. A selection control 404 corresponding to each social status is displayed on the page, and the user may click the selection control 404 to view the corresponding social status. In some embodiments, the page further includes a selection control for footprints today. If the user triggers the footprints today, a page shown in (4) in FIG. 8 is displayed. The page displays a footprint image today of the first user account. The footprint image today is generated according to posting locations of at least two social statuses posted by the first user account on the posting date, and is configured for indicating an activity track of the first user account on the posting date.

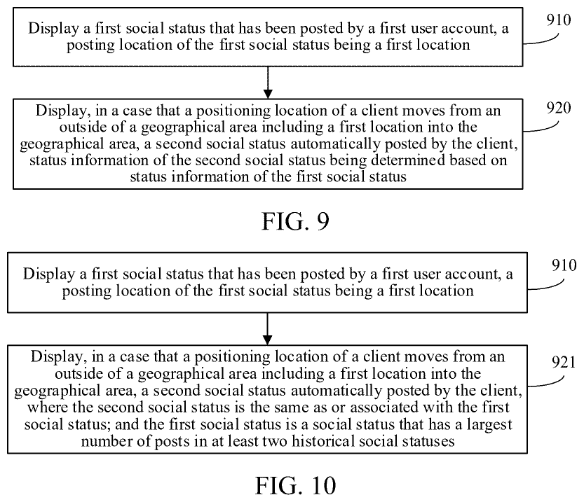

FIG. 9 shows a flowchart of a social status posting method according to an exemplary embodiment of the present disclosure. The method may be performed by a computer device, for example, the terminal shown in FIG. 1. The method includes the following operations:

Operation 910: Display a first social status that has been posted by a first user account, a posting location of the first social status being a first location.

In some embodiments, a client is a client of a first application, and the first user account is logged in on the client. The first application may be a map-based social application. Certainly, the first application may alternatively be an application of another type, for example, an instant messaging program, a social application, a browser application, a live streaming application, a video playing program, a short video playing program, an information program, a knowledge-type program, a life-type program, a shopping-type program, a picture sharing program, a community program, a forum application, or an office application.

The first user account has posted the first social status on the first application. The first social status may be social status manually edited and posted by the user. For example, a first user account posted the first social status at a first location at a first time. For example, the first user account posted a sports status on a playground at 5:00 last Friday.

The social status is social information, and is configured for recording an activity status at a location at a time. The social status may alternatively be referred to as a status, and may include a location status, social information, a life record, a clock-in message, or the like.

When posting the social status, the user may edit information such as text, a picture, audio, a video, a status type, or a posting address of the social status. The social status may include: at least one type of information of status text, a status picture, a status type, status audio, a status video, a posting location, a posting time, a posting user account, like information, and comment information.

The social status may be classified into a plurality of status types. The status type may be several fixed status types provided by the first application, or the status type may be a user-defined status type. The status type is configured for indicating an activity status of the user. For example, the status type may include: a sports status, a song listening status, a working status, a learning status, a shopping status, a game status, or the like. When posting a social status, the user may select a status type to post the social status.

Each status type may correspond to a respective status icon, status ID (identifier), and virtual character action. The status icon may be configured for marking the social status. For example, the status icon is displayed on the map image to mark a posting location of the social status.

The virtual character action is configured for representing the status type. The virtual character action is configured for determining a display mode of the virtual character of the user account, and the virtual character action may be a static action or a dynamic effect. For example, for a sports status, the virtual character action may be a running action.

The social status may be only visible to the user, may be only visible to a friend, or may be public.

The posting location is a location bound when a social status is posted, and may be referred to as the social status being posted based on the location. The social status is bound to the location. The location may be a location positioned when the social status is posted, or may be a location selected by the user. The selected location is bound to the social status when the social status is posted.

The first social status is associated with a first location, and it may be referred to as the first social status being bound to the first location. The first location is a posting location of the first social status. The first location may be an actual location where the client is located when the first social status is posted. The first location may alternatively be a location independently selected by the user.

The first location is a location actually existing in reality, and the first location may include: at least one type of location information of an address, a longitude and latitude, and positioning information.

In some embodiments, one social status may be associated with at least one location. One location allows a plurality of social statuses to be posted. The first location may be a location associated with the first social status.

Displaying a first social status may include: displaying at least one type of the following information about the first social status: status text, a status picture, a status type, a status thumbnail, a status icon (a type icon), a posting location, a posting time, and a virtual character of the first user account (the virtual character may be displayed as a virtual character action of a first status type corresponding to the first social status).

Operation 920: Display, when a positioning location of a client moves from an outside of a geographical area including a first location into the geographical area, a second social status automatically posted by the client, status information of the second social status being determined based on status information of the first social status.

For example, the client may determine, in real time according to the positioning location, whether the positioning location corresponds to a historical social status that can trigger automatic posting. For example, the client may store a social status list (an automatic posting list) that is allowed to be automatically posted. Each time the first user account manually posts a social status that is allowed to trigger automatic posting, the client stores the social status into the automatic posting list. The automatic posting list stores: a social status, and a location associated with the social status. The client may compare, in real time, the positioning location with a position stored in the automatic posting list. If the positioning location falls into a geographical area of a location, automatic posting is triggered, and the client automatically posts a new social status according to the social status corresponding to the location.

The geographical area of the first location may be a range whose distance to the first location is less than a distance threshold. Or, the geographical area of the first location may be a range delineated by the first user account based on the first location, and the geographical area includes the first location. Or, the geographical area may refer to the first location.

In an exemplary embodiment, to prevent the user from just posting the first social status and having no time to move out of the first location yet, the client automatically posts the social status again. One day after the first social status is posted, the client may allow a new social status to be automatically posted according to the first social status.

For example, when the positioning location of the client moves to the geographical area of the first location again, and posting duration of the first social status exceeds predetermined duration (for example, one day), the second social status automatically posted by the client is displayed.

Or, when a moving path of the client moves from the outside of the geographical area of the first location into the geographical area, the second social status automatically posted by the client is displayed.

The second social status is a social status automatically posted by the client according to the first social status. The second social status is associated with the first social status. For example, existence of the first social status and the second social status is that at least one type of information is the same: a status type, status text, a status image, a status thumbnail, a status icon, and a posting location. For example, the first social status is “I'm so happy to get off work” posted by the first user account at the first location. The second social status may be “I'm so happy to get off work” posted by the first user account at the first location.

A posting time of the second social status is different from that of the first social status.

In conclusion, according to the method provided in this embodiment, according to a posting location of a historical social status posted by a user account, when the client moves to the location again, the client automatically posts a new social status according to the historical social status, where status information of the new social status is determined according to status information of the historical social status. When the user wants to record daily life by posting a status, because a daily life status of the user is usually regular and repeated and fixed things are done in fixed locations, the client may determine by default, according to the historical social statuses posted by the user account and when the client passes these posting locations for posting the historical social statuses next time, that the user is doing the thing in the historical social status at the location by default, and the client may automatically post a new social status for the user account according to the historical social status, thereby improving efficiency of recording a daily status by the user and improving efficiency of posting a social status.

For example, for operation 920, this embodiment of the present disclosure further provides a plurality of modes of triggering an automatic social posting program, and a plurality of modes of automatically posting a new social status according to the historical social status.

Operation 920: Display, when a positioning location of a client moves from an outside of a geographical area including a first location into the geographical area, a second social status automatically posted by the client, status information of the second social status being determined based on status information of the first social status.

When the first user account has posted a plurality of social statuses at the first location, the client may post a new social status according to a social status that has a largest number of posts. As shown in FIG. 10, operation 920 may include operation 921: Display, when a positioning location of a client moves from an outside of a geographical area including a first location into the geographical area, a second social status automatically posted by the client, where the second social status is the same as or associated with the first social status; and the first social status is a social status that has a largest number of posts in at least two historical social statuses.

In some embodiments, the first social status may refer to a social status of the first status type posted at the first location. Each time the first user account posts a social status of the first status type at the first location, the number of posts of the first social status is increased by one.

For example, the first user account has posted the first social status ten times, a third social status once, and a fourth social status twice at the first location. When the client approaches the first location, the client generates a second posting status according to the first social status that has a largest number of posts.

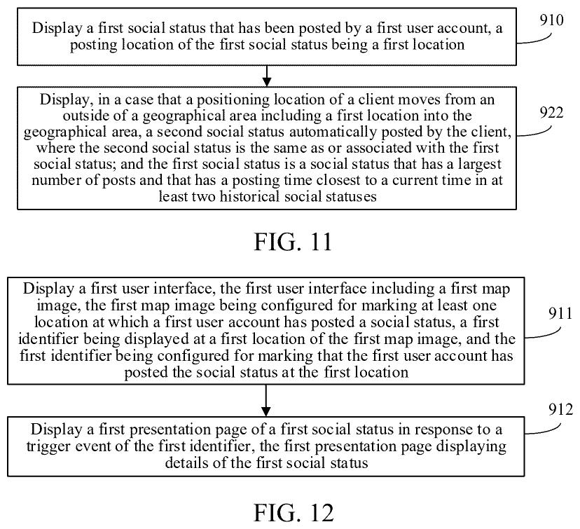

When the first user account has posted a plurality of social statuses at the first location, the client may post a new social status according to a social status that has a largest number of posts and that has a posting time closest to a current time. As shown in FIG. 11, operation 920 may include operation 922: Display, when a positioning location of a client moves from an outside of a geographical area including a first location into the geographical area, a second social status automatically posted by the client, where the second social status is the same as or associated with the first social status; and the first social status is a social status that has a largest number of posts and that has a posting time closest to a current time in at least two historical social statuses.

For example, the first user account has posted the first social status for ten times, a third social status for ten times, and a fourth social status twice at the first location. The last post of the first social status is yesterday, and the last post of the third social status is the day before yesterday. When the client approaches the first location, the client generates a second posting status according to the first social status that has a largest number of posts and that has a posting time closest to the current time.

The client may further trigger automatic posting of a social status according to two dimensions, that is, location and time. Operation 920 may include: displaying, when the positioning location of the client moves from the outside of the geographical area including the first location into the geographical area and the current time and a first time are less than a time threshold, second social status automatically posted by the client, where the posting time of the first social status is the first time.

When the first social status is a social status associated with the second application, the client may further automatically post the second social status according to the second application. The client performing the method is a client of a first application, the first social status is associated with a second application, and the first application and the second application are different applications. Operation 920 may include at least one of the following implementations.
(1) Displaying, when the positioning location of the client moves from the outside the geographical area including the first position into the geographical area, the second social status automatically posted by the client, where status information of the second social status includes application data of the second application.

For example, the first social status is a latest game record posted by the first user account in an Internet bar. When the client arrives at the Internet bar again, the client may automatically obtain the latest game record from a game application, and generate and post the second social status according to the latest game record.
(2) Displaying, when the positioning location of the client moves from the outside of the geographical area including the first location into the geographical area and a running status of the second application is a running status associated with the first social status, the second social status automatically posted by client.

For example, the running status of the second application associated with the first social status includes: a mail application is in a logged-in status. When the client moves to the first location geographical area again and the mail application is in the logged-in status, the client may automatically post the second social status.
(3) Displaying, when the positioning location of the client moves to the geographical area of the first location again and an automatic generation event of a status is triggered on the second application, the second social status automatically posted by the client, where status information of the second social status includes event information of the automatic generation event. The automatic generation event of the status includes at least one of a payment event, a schedule addition event, a conference creation event, and a sports record event.

In some embodiments, the first application may subscribe to the automatic generation event of the status of the second application. When the second application detects the automatic generation event of the status, the event information is sent to the first application. When receiving the event information, the first application identifies whether the positioning location of the client is located in a geographical area of the first position, and automatically posts the second social status if the positioning location of the client is located in the geographical area of the first position.

An example in which the automatic generation event includes a payment event is used. A posting operation of posting the first social status by the first user account may include: a status posting page is displayed, where the status posting page is configured for editing and posting the first social status; a payment event binding control is displayed in response to receiving an operation of selecting a status type to be a shopping status; and the client of the first application sends a payment event binding request to a server in response to an operation of triggering the payment event binding control, and the server of the first application sends a payment event subscription request to a server of the second application. In response to that the server of the second application returns a subscription success indication, the server of the first application returns a binding success indication to the client of the first application, and displays that the first social status is successfully bound to the payment event. In response to an operation of triggering a posting control, the first social status is displayed, where a status type of the first social status is a shopping status, and the first social status is bound to the payment event of the second application. When the payment event occurs in the second application (a user performs a payment behavior), the server of the second application sends the event information to the server of the first application. The event information includes related information of the payment event. The server of the first application sends the event information to the client of the first application. The client detects whether the positioning location is located in the geographical area of the first position, and the client automatically posts the second social status according to the event information if the positioning location is located in the geographical area of the first position.

An example in which the automatic generation event includes a conference creation event is used. A posting operation of posting the first social status by the first user account may include: the client of the first application receives the first conference status creation request sent by the second application, where the first conference status creation request includes detailed information of a conference created in the second application, and the detailed information may include: a conference start time, conference duration, a conference subject, conference attendees, and the like. The first application displays a status posting page according to the first conference status creation request, and the status posting page displays status content determined according to the detailed information. The first social status is posted in response to a posting operation, where the first social status is bound to the conference creation event of the second application. When the user creates the conference again by using the second application, the second application sends the second conference status creation request to the first application again. The client of the first application detects whether the positioning location is located in the geographical area of the first position. The client automatically posts the second social status according to the second conference status creation request if the positioning location is located in the geographical area of the first position, where status content of the second social status includes the detailed information of the conference carried in the second conference status creation request.

For example, when the user pays a meal fee by using the payment application, the payment application sends event information of the payment event to the first application, where the event information includes: at least one of a payment amount, a payment time, a payee, and a payment mode. After receiving the event information, the client of the first application automatically posts the second social status if the positioning location is located in the geographical area of the first position. The second social status includes at least one type of information in the event information.

In some embodiments, the first social status may alternatively be a social status generated according to a template, and the second social status is also generated according to the template. The first social status is posted according to a social status template. The social status template includes customized content and template content. The customized content is content input by a user, and the template content is content automatically generated according to the social status template. The second social status is posted according to a social status template of the first social status, customized content of the second social status is the same as the customized content of the first social status, and the template content of the second social status includes at least one of a client status and historical posting information of the first social status. The client status includes at least one of the following: a current time and a positioning location; and the historical posting information of the first social status includes a number of posts of the first social status.

For example, the first social status may be a social status of a sports clock-in generated according to a sports template, and the first social status includes “an nth day of persisting in running”, where “persisting in running” is the customized content input by the user; “an nth day of” is the template content, and a value of n depends on the number of posts of the first social status. The client may automatically determine a value of n in the second social status according to the number of posts of the first social status. For example, if the number of posts of the first social status is n, the client replaces the template content in the second social status with “an (n+1)^{th} day of”, and the second social status is, “an (n+1)^{th} day of persisting in running”.

In conclusion, according to the method provided in this embodiment, the client may trigger automatic posting of a social status according to a trigger condition such as a location, a time, or an application event. Accuracy and fineness of posting a social status are improved, a life status of the user is accurately and timely recorded, operations of the user for posting the social status are reduced, and efficiency of posting the social status by the user is improved.

For example, a plurality of modes of viewing the historical social status of the first user account are provided.
(1) The user may view a corresponding social status by triggering a location identifier on a map image.

FIG. 12 shows a flowchart of a social status posting method according to an exemplary embodiment of the present disclosure. The method may be performed by a computer device, for example, the terminal shown in FIG. 1. Based on any embodiment described above, operation 910 may include operation 911 and operation 912.

Operation 911: Display a first user interface, the first user interface including a first map image, the first map image being configured for marking at least one location at which a first user account has posted a social status, a first identifier being displayed at a first location of the first map image, and the first identifier being configured for marking that the first user account has posted the social status at the first location.

For example, the map image (including the first map image and a plurality of subsequent map images) may respond to a user operation. The user may drag the map image to view different locations, and the user may further zoom in or out the map image to change a geographical range displayed in the map image.

For example, the first user interface may be a main interface of the first application. A positioning location of the first user account, a positioning location of a friend of the first user account, and at least one location that has been checked in by the first user account are marked on the map image of the main interface. The positioning location of the user account may be marked on the map image by using user account information. A checked-in location may be marked on the map image by using a social icon of a social status. The user may view a corresponding social status by clicking the status icon on the map image.

In some embodiments, the first identifier may further be displayed as a virtual character of the first user account. The virtual character performs a virtual character action corresponding to the first social status at the first location. Operation 911 may include: rendering the virtual character by using a three-dimensional animation rendering engine, to obtain a first rendering result; rendering the first map image by using a map rendering engine, to obtain a second rendering result; and displaying the first rendering result at the first location in the second rendering result in an overlapping mode, to obtain the first map image, where the first map image includes the virtual character displayed at the first location.

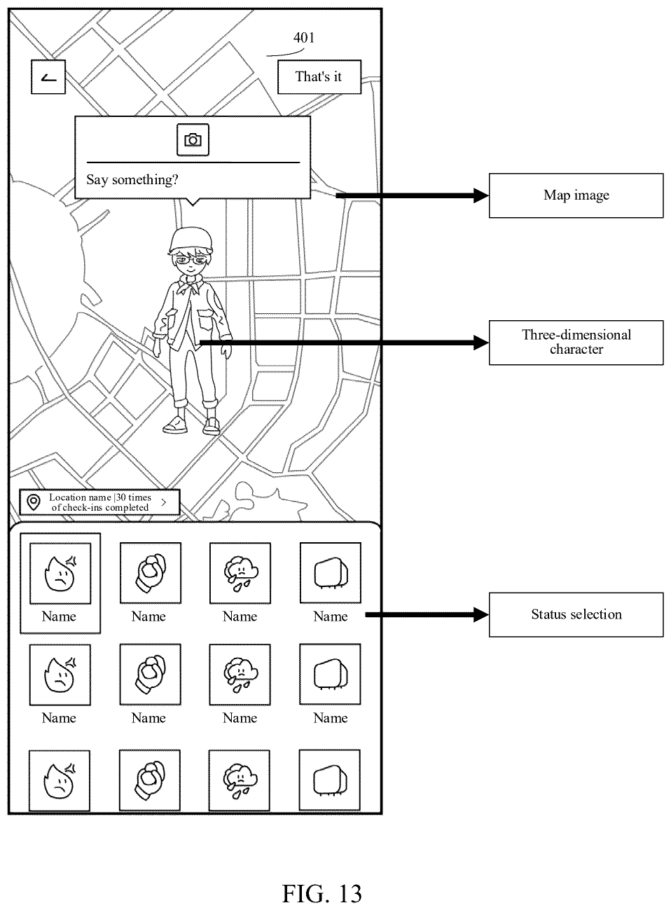

For example, as shown in FIG. 13, a map image 401 is rendered by using a map rendering engine, and a virtual character is rendered by using a Unity rendering engine. The virtual character and a status selection page are displayed on the map image in an overlapping mode, and the first user interface is displayed.

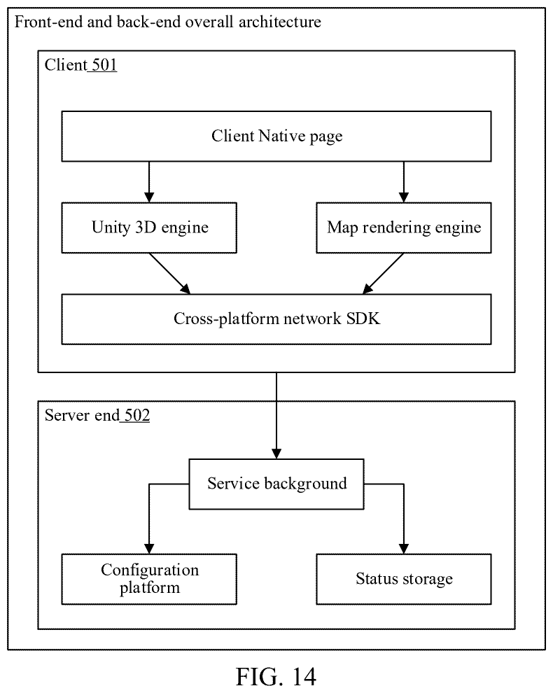

In some embodiments, as shown in FIG. 14, a client 501 displays a client Native page. The client Native page refers to a hub that integrates an avatar rendered by a Unity 3D engine, a map geographic location, and a map-related product self-defined rendering element (a map avatar, a map geographic location image, a check-in location image) by using Java/Kotlin/Swift and using application programming interface (API) part of an Android/IOS system. A service backend module of a server end 502 is responsible for storing an avatar image configuration, check-in location coordinates and a status of a user, and interacts with the client 501. The configuration is parsed by the client 501, is parsed by a corresponding rendering engine, and is displayed on a screen.

Operation 912: Display a first presentation page of a first social status in response to a trigger event of the first identifier, the first presentation page displaying details of the first social status.

The trigger event for the first identifier is an event of triggering a function by using the first identifier, may be a trigger operation for the first identifier, may be a touch operation for the first identifier, a voice control operation indicating the first identifier, or the like. The trigger event may be set according to requirements, or may be set differently according to different types of the first identifier.

In some embodiments, if the first user account has posted at least two social statuses at the first location, the first social status is a first status type. Operation 912 may include: displaying a social status list in response to the trigger event for the first identifier, the social status list being configured for displaying at least two status types that have been posted by the first user account at the first location, and at least two status types including a first status type, and the at least two status types are sorted in the social status list in reverse order of a posting time; displaying, in response to the first status type being triggered in the social status list, at least one social status that is of the first status type and that has been posted by the first user account at the first location, the at least one social status including the first social status; and displaying, in response to selecting the first social status from the at least one social status, the first presentation page of the first social status (referring to (3), (4), and (5) in FIG. 4).

In some embodiments, the user may click a location information entry to enter a location detail page. When the location is checked in for the first time, the location detail page presents: current address details, a “change positioning” button, a default illustration, and guidance copywriting. When the location is not checked in for the first time, the location detail page presents: current address details, an accumulated number of check-ins, a “change positioning” button, and a posted status list. The number of check-ins does not need to be omitted, and a specific value is presented.

In some embodiments, the status list includes: a status icon, a status name, the number of check-ins, and an expand/collapse button. Classification is performed according to a status type, and a status with a larger number of check-ins is sorted in front. When the numbers of check-ins are the same, the statuss are sorted in reverse order according to the time order of posting the statuss. The number of check-ins does not need to be omitted, and a specific value is presented. The user may click an “expand” button to present content details corresponding to the social status.

A plurality of social statuses of the same status type are sorted in reverse order according to the time order of posting, and are classified according to month order. If an image is added to a single status, the single status is displayed as a thumbnail of the corresponding image. If there is no image but there is text, the text is presented. If there is no image/text, a status icon of a corresponding status is presented. If a single social status is clicked, a corresponding status detail page is jumped to and opened.
(2) The user may view a corresponding social status by triggering a jump control on the map image.

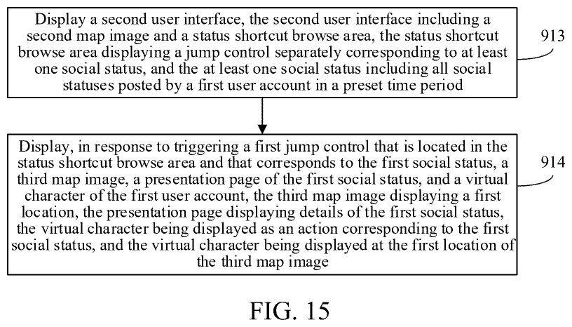

FIG. 15 shows a flowchart of a social status posting method according to an exemplary embodiment of the present disclosure. The method may be performed by a computer device, for example, the terminal shown in FIG. 1. Based on any embodiment described above, operation 910 may include operation 913 and operation 914.

Operation 913: Display a second user interface, the second user interface including a second map image and a status shortcut browse area, the status shortcut browse area displaying a jump control separately corresponding to at least one social status, and the at least one social status including all social statuses posted by a first user account in a preset time period.

The preset time may be time set by a server end of the first application, or, the preset time may be time set by the first user account. For example, the preset time may be today.

For example, as shown in (1) in FIG. 5, three jump controls 403 respectively corresponding to three social statuses are displayed below the interface. The user may trigger any jump control to display a posting location of the social status corresponding to the jump control in a center of the map image, and to display a detail page of the social status on the map image in an overlapping mode.

In some embodiments, in the status shortcut browse area, a jump control corresponding to at least one social status is sorted in reverse order of a posting time of the social status. That is, the jump control of the social status having a closer posting time is sorted more front. A user can quickly view a social status posted today.

Operation 914: Display, in response to triggering a first jump control that is located in the status shortcut browse area and that corresponds to the first social status, a third map image, a presentation page of the first social status, and a virtual character of the first user account, the third map image displaying a first location, the presentation page displaying details of the first social status, the virtual character being displayed as an action corresponding to the first social status, and the virtual character being displayed at the first location of the third map image.

For example, as shown in (2) in FIG. 5, in response to triggering a second jump control, the map image is locked at the posting location corresponding to the social status, the virtual character of the first user account is further displayed at the posting location, and details of the social status are displayed on the map image in an overlapping mode. Details of the social status include: information such as an image, text, a posting location, a status type, liking, and a comment.
(3) The user may view a corresponding social status by using a personal center interface of the user account.

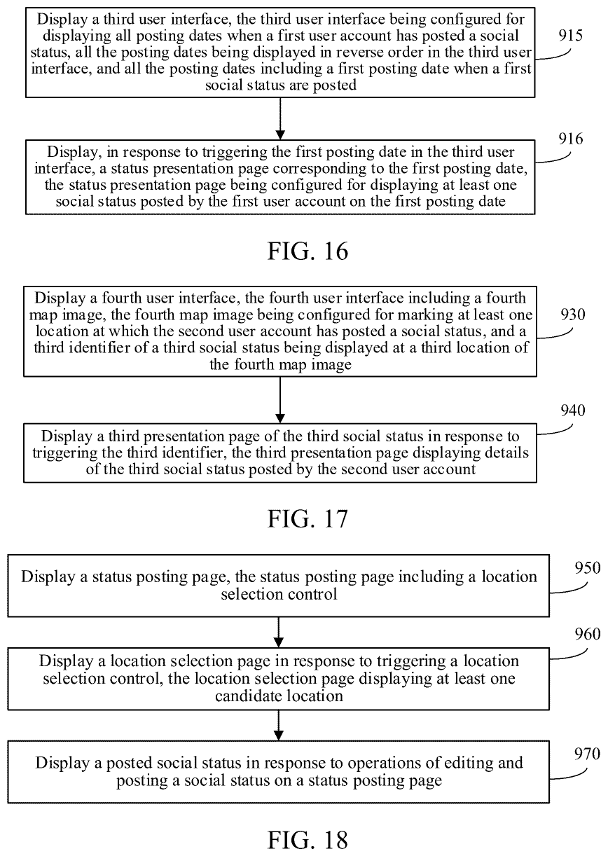

FIG. 16 shows a flowchart of a social status posting method according to an exemplary embodiment of the present disclosure. The method may be performed by a computer device, for example, the terminal shown in FIG. 1. Based on any embodiment described above, operation 910 may include operation 915 and operation 916.

Operation 915: Display a third user interface, the third user interface being configured for displaying all posting dates when a first user account has posted a social status, all the posting dates being displayed in reverse order in the third user interface, and all the posting dates including a first posting date when a first social status is posted.

The third user interface may be a personal center interface of a first user account. For example, (1) in FIG. 8 shows a personal center interface.

In some embodiments, in the third user interface, all posting dates when the first user account has posted the social status in a form of a calendar.

Operation 916: Display, in response to triggering the first posting date in the third user interface, a status presentation page corresponding to the first posting date, the status presentation page being configured for displaying at least one social status posted by the first user account on the first posting date.

In some embodiments, details of the first social status on the status presentation page are displayed when the first user account has only posted the first social status on the first posting date.

A social status selection control is displayed on the status presentation page when the first user account has posted at least two social statuses on the first posting date; and the details of the first social status are displayed on the status presentation page in response to triggering the social status selection control to select the first social status. That is, the user account may switch to view all social statuses on the first posting date on the status presentation page.

In some embodiments, the status presentation page further includes a first footprint display area, the first footprint display area displays a footprint image, and the footprint image is a footprint image generated on the map image according to a posting location of at least one social status posted by the first user account on the first posting date.

That is, the client may generate a moving track of a day of the first user account on the map image according to the at least one social status posted on the first posting date, and display the image of the moving track in the first footprint display area.

In some embodiments, the status presentation page further includes a second footprint display area, the second footprint display area displays a footprint video, and the footprint video includes an image in which the virtual character of the first user account moves on the map image. The moving path of the virtual character on the map image is determined according to a posting time and a posting location of at least one social status posted by the first user account within the first posting date. The virtual character performs an i^{th} action corresponding to an i^{th} social status at an i^{th} posting location of the i^{th} social status of the at least one social status, and the virtual character moves to an (i+1)^{th} posting location corresponding to an (i+1)^{th} social status after performing the i^{th} action, a posting time of the (i+1)^{th} social status being later than that of the i^{th} social status, and i being a positive integer.

That is, the client may generate the moving track according to at least one social status posted on the first posting date, the virtual character action corresponding to each social status, and the virtual character of the first user account. The virtual character is configured for generating a path animation of the day of the first user account, to vividly present a current moving path and activity statuss of the first user account at various locations.

In conclusion, according to the method provided in this embodiment, a plurality of modes of viewing a historical social status are provided. In a main interface of an application, a user may click an identifier of a corresponding location on the map image to enter a social status page of the location, and view, on the page, all social statuses posted at the location. Or, the user may view, by entering the personal center page, all social statuses presented in a form of a calendar. The user may view, by clicking a date, all social statuses posted on the date. Or, a jump control of a social status posted in one day may be displayed on the main interface, so that the user triggers the jump control to quickly view the corresponding social status. Efficiency of searching for a social status by a user is improved, and social statuses are classified and presented in different dimensions, to facilitate browsing by the user.

For example, the user may further view a social status of another user account.

FIG. 17 shows a flowchart of a social status posting method according to an exemplary embodiment of the present disclosure. The method may be performed by a computer device, for example, the terminal shown in FIG. 1. Based on any embodiment described above, the method may further include operation 930 and operation 940.

Operation 930: Display a fourth user interface, the fourth user interface including a fourth map image, the fourth map image being configured for marking at least one location at which the second user account has posted a social status, and a third identifier of a third social status being displayed at a third location of the fourth map image.

For example, the fourth user interface is configured for displaying a positioning location and a check-in location (a location at which the social status has been posted) of a second user account. The first user account may view details of the social status posted by the second user account by triggering the check-in location.

In some embodiments, before operation 930, the method may further include: displaying a fifth user interface, the fifth user interface including a fifth map image, the fifth map image being configured for displaying real-time locations of the first user account and at least one friend account, the at least one friend account being a user account that has a friend relationship with the first user account, and the at least one friend account including the second user account. Operation 930 may include: displaying the fourth user interface in response to selecting the second user account on the fifth map image, a positioning location of the second user account being located at an image center of the fourth map image.

In some embodiments, the fifth user interface may be the foregoing first user interface, that is, the fifth user interface is configured for presenting the check-in location of the first user account. If the user wants to view a check-in location of another user account, the user may click the another user account to switch to check-in location presentation interface of the another user account. After switching, a location marked on the map image changes from the check-in location of the first user account to the check-in location of the another user account.

Operation 940: Display a third presentation page of the third social status in response to triggering the third identifier, the third presentation page displaying details of the third social status posted by the second user account.

In the check-in location presentation interface of the second user account, the user may trigger an identifier whose location is marked in the check-in location presentation interface, to view the details of the social status posted by the second user account at the location.

In conclusion, according to the method provided in this embodiment, the client may display the social status posted by another user account, so that a user can learn a life status of the another user account. In addition, the another user account may alternatively automatically post the social status according to the location, so that the user can learn a positioning location and a status of a friend in time.

For example, an embodiment in which a user manually posts a social status is provided.

FIG. 18 shows a flowchart of a social status posting method according to an exemplary embodiment of the present disclosure. The method may be performed by a computer device, for example, the terminal shown in FIG. 1. Based on any embodiment described above, the method may further include operation 950, operation 960, and operation 970.

Operation 950: Display a status posting page, the status posting page including a location selection control.

In some embodiments, a main interface of a client may alternatively be displayed as a map image. A posting control may be displayed in the main interface, and the status posting page is displayed in response to receiving an operation of triggering the posting control. User positioning location information is obtained by default in the status posting page. Whether there is a location at which the user has checked in (that is, a social status at a binding location has been posted) is obtained within a range of 100 m around a current location of the user. If there is a location at which the user checks in, a corresponding location is presented by default; and if there is no location at which the user checks in, a current actual location is presented. If a plurality of locations at which the user has checked in (the social status) within a range of 100 m, a latest check-in location is presented.

In some embodiments, when location information is presented, if a status is posted for the first time at a positioning location, copywriting presents “first check-in of this location”. If the status is not posted at the positioning location for the first time, a number of the statuss posted at the positioning location needs to be counted, and copywriting presents “x times of check-ins completed”, x does not need to be omitted, and a specific value is directly presented.

In some embodiments, when the user adds an image (that is, a status selection panel is collapsed), an entry “Add location information” is added at a bottom. If a location is not authorized, copywriting is “Authorize to add location information”. If the location is authorized, the entry presents: a “close” button+location information+first check-in of this location, or a “close” button+location information+x times of check-ins completed.

In some embodiments, the user may select whether to automatically update the social status according to a real-time location. If the option is opened, the social status previously set is automatically posted when the user passes through the location subsequently.

In some embodiments, the status posting page displays a first posting location that has already been selected. When the first user account has not posted the social status at the first posting location, the social posting page further displays prompt information about first check-in. When the first user account has posted the social status at the first posting location, the social posting page further displays a number of check-ins completed. The number of check-ins completed includes a number of the social statuses that have been posted by the first user account at the first posting location.

Operation 960: Display a location selection page in response to triggering of a location selection control, the location selection page displays at least one candidate location.

When the candidate range includes a historical posting location of the social status that has been posted by the first user account, the at least one candidate location including a historical posting location, the candidate range being determined according to the positioning location of the client. The historical posting locations are sorted according to a number of posts of the social statuses. When the first user account has not posted the social status in the candidate range, the at least one candidate location includes the positioning location of the client.

Operation 970: Display a posted social status in response to operations of editing and posting a social status on a status posting page.

In some embodiments, the status posting page includes a posting control. After editing the social status on the status posting page, the user may trigger the posting control to post the social status.

In conclusion, according to the method provided in this embodiment, the user may further manually post the social status. On a social status posting page, a nearby check-in location may be automatically recommended to the user according to a positioning location, so that the user quickly selects a location that needs to be checked in, thereby improving efficiency of posting the social status. If the user has never checked in at the location, a first check-in prompt may alternatively be displayed, to encourage the user to post a social status at more locations.

For example, an embodiment of posting a social status is provided.

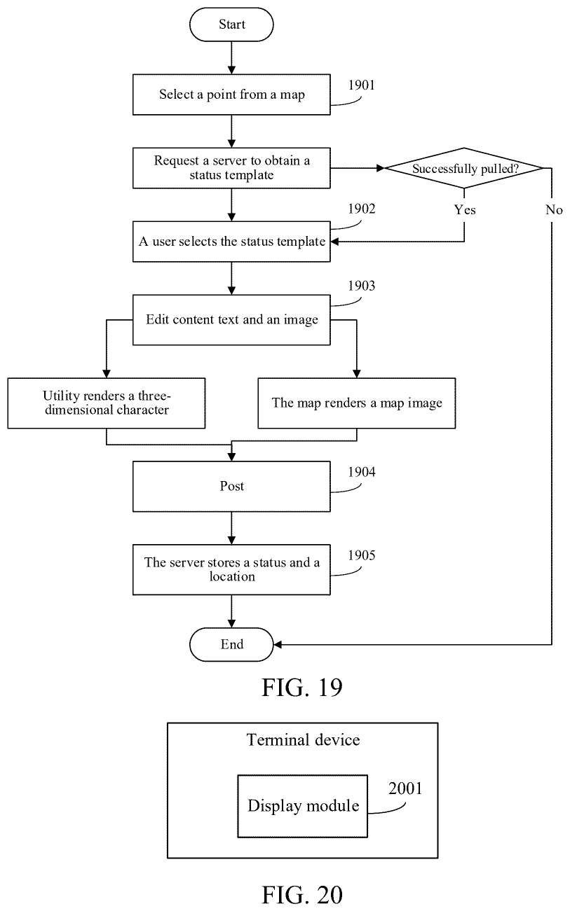

FIG. 19 shows a flowchart of a social status posting method according to an exemplary embodiment of the present disclosure. The method may be performed by a terminal and a server. The method includes the following operations.

Operation 1901: A terminal receives an operation of selecting a location on a map, and sends a status template obtaining request to a server, the status template obtaining request being configured for requesting to obtain a social status template corresponding to the location.

Operation 1902: If the social status template is successfully obtained, the terminal displays the social status template, and receives an operation of selecting the social status template by the user.

If the social status template fails to be pulled, a process is ended.

Operation 1903: The terminal displays a social status posting page according to the social status template selected by the user. An editing operation for the social status on the social status posting page is received, where the editing operation includes an operation of editing content text and an image.

Operation 1904: If the user posts a social status, the terminal renders, according to a status selected by the user and a posting location selected by the user, a virtual character by using a Unity engine, renders a map image by using a map rendering engine, and displays a social status posting result. The social status is reported to the server.

The virtual character may be displayed as a dynamic effect, or may be displayed as a static image. The virtual character rendering engine may alternatively use another three-dimensional rendering engine.

Operation 1905: The server stores the social status and the posting location of the social status.

In conclusion, according to the method provided in this embodiment, the virtual character is rendered by using the Unity engine, so that an animation effect is very vivid. The map image is rendered by the map rendering engine. Rendering the virtual character and rendering the map image do not interfere with each other. The two rendering results are complementary in terms of product visual effects, and form a visual impact, thereby greatly improving product quality.

The following describes apparatus embodiments of the present disclosure. For details not described in the apparatus embodiments, refer to corresponding descriptions in the foregoing method embodiments. Details are not described in this specification again.

FIG. 20 is a schematic structural diagram of a social status posting apparatus according to an exemplary embodiment of the present disclosure. The apparatus may be implemented as all or a part of a computer device by software, hardware, or a combination of software and hardware. The apparatus is installed with a client on which a first user account logs in. The apparatus includes:
a display module 2001, configured to display a first social status posted by the first user account, a posting location of the first social status being a first location; and
the display module 2001, configured to display, when a positioning location of the client moves from an outside of a geographical area including a first location into the geographical area, a second social status automatically posted by the client, status information of the second social status being determined based on status information of the first social status.

In an exemplary embodiment, the first user account has posted at least two historical social statuses at the first location, and the at least two historical social statuses include the first social status.

The display module 2001 is configured to display the second social status automatically posted by the client, the second social status being the same as or associated with the first social status, where
the first social status is a c status that has a largest number of posts in the at least two historical social statuses.

In an exemplary embodiment, the first user account has posted at least two historical social statuses at the first location, and the at least two historical social statuses include the first social status.

The display module 2001 is configured to display the second social status automatically posted by the client, the second social status being the same as or associated with the first social status, where
the first social status is a social status that has a largest number of posts and that has a posting time closest to a current time in the at least two historical social statuses.

In an exemplary embodiment, the posting time of the first social status is the first time.

The display module 2001 is configured to display, when the positioning location of the client moves from the outside of the geographical area including the first location into the geographical area and the current time and the first time are less than a time threshold, the second social status automatically posted by the client.

In an exemplary embodiment, the client is a client of a first application, the first social status is associated with a second application, and the first application and the second application are different applications.

The display module 2001 is configured to display, when the positioning location of the client moves from the outside the geographical area including the first position into the geographical area, the second social status automatically posted by the client, where status information of the second social status includes application data of the second application; or,
the display module 2001 is configured to display, when the positioning location of the client moves from the outside of the geographical area including the first location into the geographical area and a running status of the second application is a running status associated with the first social status, the second social status automatically posted by the client; or,
the display module 2001 is configured to display, when the positioning location of the client moves from the outside of the geographical area including the first location into the geographical area and an automatic generation event of a status is triggered on the second application, the second social status automatically posted by the client, status information of the second social status including event information of the automatic generation event. The automatic generation event of the status includes at least one of a payment event, a schedule addition event, a conference creation event, and a sports record event.

In an exemplary embodiment, the first social status is posted according to a social status template, the social status template includes customized content and template content, the customized content is content input by a user, and the template content is content automatically generated according to the social status template.

The second social status is posted according to a social status template of the first social status, customized content of the second social status is the same as the customized content of the first social status, and the template content of the second social status includes at least one of a client status and historical posting information of the first social status. The client status includes at least one of the following: a current time and a positioning location. The historical posting information of the first social status includes a number of posts of the first social status.

In an exemplary embodiment, the displaying a first social status posted by the first user account includes:
the display module 2001, configured to display a first user interface, the first user interface including a first map image, the first map image being configured for marking at least one location at which the first user account has posted a social status, a first identifier being displayed at the first location of the first map image, and the first identifier being configured for marking that the first user account has posted the social status at the first location; and
the display module 2001, configured to display a first presentation page of the first social status in response to a trigger event for the first identifier, the first presentation page displaying details of the first social status.

In an exemplary embodiment, the first user account has posted at least two social statuses at the first location. The first social status is a first status type.

The display module 2001 is configured to display a social status list in response to a trigger event for the first identifier, the social status list being configured for displaying at least two status types that have been posted by the first user account at the first location, the at least two status types including the first status type, and the at least two status types being sorted in the social status list according to the number of check-ins;
the display module 2001 is configured to display, in response to that the first status type is triggered in the social status list, at least one social status that is of the first status type and that has been posted by the first user account at the first location, the at least one social status including the first social status; and
the display module 2001 is configured to display, in response to selecting the first social status from the at least one social status, the first presentation page of the first social status.

In an exemplary embodiment, the first identifier includes a virtual character of the first user account, and the virtual character performs an action corresponding to the first social status at the first location.

The display module 2001 is configured to render the virtual character by using a three-dimensional animation rendering engine, to obtain a first rendering result;
the display module 2001 is configured to render the first map image by using a map rendering engine, to obtain a second rendering result; and
the display module 2001 is configured to display the first rendering result at the first location in the second rendering result in an overlapping mode, to obtain the first map image, the first map image including the virtual character displayed at the first location.

In an exemplary embodiment, the display module 2001 is configured to display a second user interface, the second user interface including a second map image and a status shortcut browse area, the status shortcut browse area displaying a jump control separately corresponding to at least one social status, and the at least one social status including all social statuses posted by the first user account in a preset time period.

The display module 2001 is configured to display, in response to triggering a first jump control that is located in the status shortcut browse area and that corresponds to the first social status, a third map image, a presentation page of the first social status, and the virtual character of the first user account, the third map image displaying the first location, the presentation page displaying the details of the first social status, the virtual character displaying an action corresponding to the first social status, and the virtual character being displayed at the first location of the third map image.

In an exemplary embodiment, the display module 2001 is configured to display a third user interface, the third user interface being configured for displaying all posting dates when a first user account has posted a social status, all the posting dates being displayed in reverse order in the third user interface, and all the posting dates including a first posting date when a first social status is posted;
the display module 2001 is configured to display, in response to triggering the first posting date in the third user interface, a status presentation page corresponding to the first posting date, the status presentation page being configured for displaying at least one social status posted by the first user account on the first posting date; and
the display module 2001 is configured to: display the details of the first social status on the status presentation page when the first user account has only posted the first social status on the first posting date;
display a social status selection control on the status presentation page when the first user account has posted at least two social statuses on the first posting date; and display the details of the first social status on the status presentation page in response to triggering the social status selection control to select the first social status.

In an exemplary embodiment, the status presentation page further includes a first footprint display area, the first footprint display area displays a footprint image, and the footprint image is a footprint image generated on the map image according to a posting location of at least one social status posted by the first user account on the first posting date.

In an exemplary embodiment, the status presentation page further includes a second footprint display area, the second footprint display area displays a footprint video, and the footprint video includes an image in which the virtual character of the first user account moves on the map image;
a moving path of the virtual character on the map image being determined according to a posting time and a posting location of at least one social status posted by the first user account within the first posting date; and performing, by the virtual character at an i^{th} posting location of an i^{th} social status in the at least one social status, an i^{th} action corresponding to the i^{th} social status, and moving, by the virtual character, to an (i+1)^{th} posting location corresponding to an (i+1)^{th} social status after performing the i^{th} action, a posting time of the (i+1)^{th} social status being later than that of the i^{th} social status, and i being a positive integer.

In an exemplary embodiment, the display module 2001 is configured to display a fourth user interface, the fourth user interface including a fourth map image, the fourth map image being configured for marking at least one location at which the second user account has posted a social status, and a third identifier of a third social status being displayed at a third location of the fourth map image; and
the display module 2001 is configured to display a third presentation page of the third social status in response to triggering the third identifier, the third presentation page displaying details of the third social status posted by the second user account.

In an exemplary embodiment, the display module 2001 is configured to display a fifth user interface, the fifth user interface including a fifth map image, the fifth map image being configured for displaying real-time locations of the first user account and at least one friend account, the at least one friend account being a user account that has a friend relationship with the first user account, and the at least one friend account including the second user account; and
the display module 2001 is configured to display the fourth user interface in response to selecting the second user account on the fifth map image, a positioning location of the second user account being located at an image center of the fourth map image.

In an exemplary embodiment, the display module 2001 is configured to display a status posting page, the status posting page including a location selection control; and
the display module 2001 is configured to display a location selection page in response to triggering the location selection control, the location selection page displaying at least one candidate location, where
when a candidate range includes a historical posting location at which the first user account has posted the social status, the at least one candidate location includes the historical posting location, and the candidate range is determined according to the positioning location of the client; the historical posting locations are sorted according to a number of posts of the social status; and
the at least one candidate location includes the positioning location of the client when the first user account has not posted the social status in the candidate range.

In an exemplary embodiment, the status posting page displays a selected first posting location, where
the social posting page further displays prompt information about first check-in when the first user account has not posted the social status at the first posting location; and
when the first user account has posted the social status at the first posting location, the social posting page further displays a number of check-ins completed, the number of check-ins completed including a number of the social statuses that have been posted by the first user account at the first posting location.

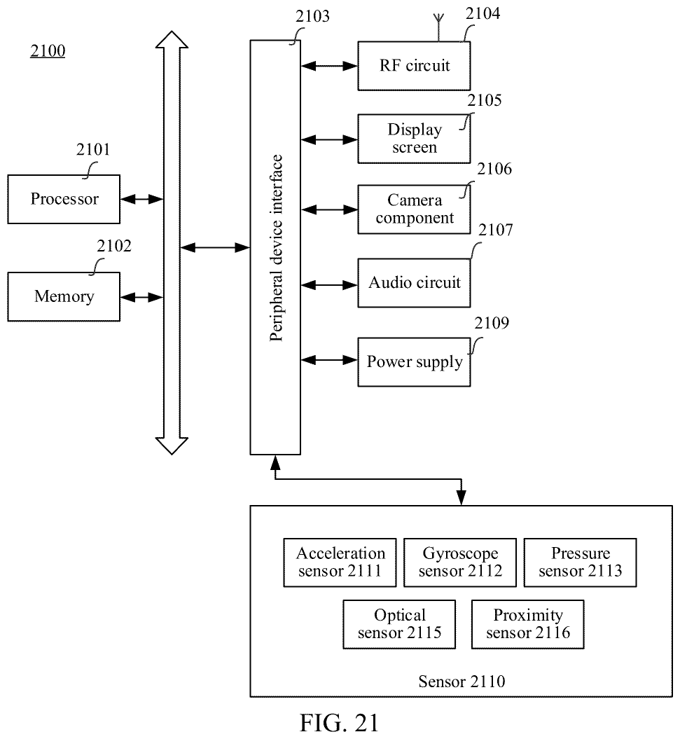

The present disclosure further provides a terminal. The terminal includes a processor and a memory. The memory stores at least one instruction. The at least one instruction is loaded and executed by the processor to implement the social status posting method according to any one of the foregoing method embodiments. The terminal may be a terminal provided in FIG. 21.

FIG. 21 is a structural block diagram of a terminal 2100 according to an exemplary embodiment of the present disclosure. The terminal 2100 may be a smartphone, a tablet computer, a moving picture experts group audio layer III (MP3) player, a moving picture experts group audio layer IV (MP4) player, a notebook computer, or a desktop computer. The terminal 2100 may alternatively be referred to by another name such as a user account device, a portable terminal, a laptop terminal, or a desktop terminal.

Generally, the terminal 2100 includes: a processor 2101 and a memory 2102.

The processor 2101 may include one or more processing cores, for example, a 4-core processor or an 8-core processor. The processor 2101 may be implemented in at least one hardware form of a digital signal processor (DSP), a field-programmable gate array (FPGA), and a programmable logic array (PLA). The processor 2101 may alternatively include a main processor and a coprocessor. The main processor is a processor configured to process data in an awake status, and is alternatively referred to as a central processing unit (CPU). The coprocessor is a low power consumption processor configured to process the data in a standby status. In some embodiments, the processor 2101 may be integrated with a graphics processing unit (GPU). The GPU is configured to render and draw content that needs to be displayed on a display screen. In some embodiments, the processor 2101 may further include an artificial intelligence (AI) processor. The AI processor is configured to process computing operations related to machine learning.

The memory 2102 may include one or more computer-readable storage media. The computer-readable storage medium may be non-transient. The memory 2102 may further include a high-speed random access memory and a nonvolatile memory, for example, one or more disk storage devices or flash storage devices. In some embodiments, the non-transitory computer-readable storage medium in the memory 2102 is configured to store at least one instruction, and the at least one instruction is configured to be executed by the processor 2101 to implement the social status posting method provided by the method embodiments of the present disclosure.

In some embodiments, the terminal 2100 further includes: a peripheral device interface 2103 and at least one peripheral device. The processor 2101, the memory 2102, and the peripheral device interface 2103 may be connected through a bus or a signal line. Each peripheral device may be connected to the peripheral device interface 2103 through a bus, a signal line, or a circuit board. Specifically, the peripheral device includes: at least one of a radio frequency (RF) circuit 2104, a display screen 2105, a camera component 2106, an audio circuit 2107, or, a power supply 2109.

The peripheral device interface 2103 may be configured to connect the at least one peripheral device related to input/output (I/O) to the processor 2101 and the memory 2102. In some embodiments, the processor 2101, the memory 2102, and the peripheral device interface 2103 are integrated on the same chip or circuit board. In some other embodiments, any or two of the processors 2101, the memory 2102, and the peripheral device interface 2103 may be implemented on an independent chip or circuit board. This is not limited in the embodiments.

The RF circuit 2104 is configured to receive and transmit an RF signal, also referred to as an electromagnetic signal. The RF circuit 2104 communicates with a communication network and other communication devices through the electromagnetic signal. The RF circuit 2104 converts an electric signal into an electromagnetic signal for sending, or converts a received electromagnetic signal into an electric signal. For example, the RF circuit 2104 includes: an antenna system, an RF transceiver, one or more amplifiers, a tuner, an oscillator, a DSP, an encoding and decoding chipset, a user account identity module card, and the like. The RF circuit 2104 may communicate with other terminals through at least one wireless communication protocol. The wireless communications protocol includes, but is not limited to, the World Wide Web, a metropolitan area network, the Intranet, various generations of mobile communication networks (2G, 3G, 4G, and 5G), a wireless local area network, and/or a wireless fidelity (Wi-Fi) network. In some embodiments, the RF 2104 may further include a circuit related to NFC. This is not limited in the present disclosure.

The display screen 2105 is configured to display a user interface (UI). The UI may include a graph, text, an icon, a video, and any combination thereof. When the display screen 2105 is a touch display screen, the display screen 2105 further has a capability of collecting a touch signal on or above a surface of the display screen 2105. The touch signal may be inputted to the processor 2101 as a control signal for processing. In this case, the display screen 2105 may further be configured to provide a virtual button and/or a virtual keyboard that are/is also referred to as a soft button and/or a soft keyboard. In some embodiments, the display screen 2105 may be a front panel provided with the terminal 2100. In some other embodiments, there may be at least two display screens 2105 respectively arranged on different surfaces of the terminal 2100 or in a folded design. In some embodiments, the display screen 2105 may be a flexible display arranged on a curved surface or a folded surface of the terminal 2100. Even, the display screen 2105 may be further set in a non-rectangular irregular pattern, namely, a special-shaped screen. The display screen 2105 may be prepared by using a material such as a liquid crystal display (LCD), or an organic light-emitting diode (OLED).

The camera component 2106 is configured to capture images or videos. For example, the camera component 2106 includes a front-facing camera and a rear-facing camera. Generally, the front-facing camera is disposed on the front panel of the terminal, and the rear-facing camera is disposed on a back surface of the terminal. In some embodiments, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 2106 may further include a flash. The flash may be a monochrome temperature flash, or may be a double color temperature flash. The double color temperature flash refers to a combination of a warm light flash and a cold light flash, and may be used for light compensation under different color temperatures.

The audio circuit 2107 may include a microphone and a speaker. The microphone is configured to acquire sound waves of user accounts and surroundings, and convert the sound waves into electrical signals and input the signals to the processor 2101 for processing, or input the signals to the RF circuit 2104 to implement voice communication. For the purpose of stereo sound collection or noise reduction, there may be a plurality of microphones, respectively arranged at different parts of the terminal 2100. The microphone may further be an array microphone or an omni-directional acquisition type microphone. The speaker is configured to convert the electrical signal from the processor 2101 or the RF circuit 2104 into sound waves. The speaker may be a conventional film speaker, or may be a piezoelectric ceramic speaker. When the speaker is the piezoelectric ceramic speaker, the speaker not only can convert an electric signal into acoustic waves audible to a human being, but also can convert an electric signal into acoustic waves inaudible to a human being, for ranging and other purposes. In some embodiments, the audio circuit 2107 may further include an earphone jack.

The power supply 2109 is configured to supply power to components in the terminal 2100. The power supply 2109 may be an alternating current, a direct current, a disposable battery, or a rechargeable battery. When the power supply 2109 includes a rechargeable battery, and the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast-charging technology.

In some embodiments, the terminal 2100 further includes one or more sensors 2110. The one or more sensors 2110 include, but are not limited to: an acceleration sensor 2111, a gyroscope sensor 2112, a pressure sensor 2113, an optical sensor 2115, and a proximity sensor 2116.

The acceleration sensor 2111 may detect a magnitude of acceleration on three coordinate axes of a coordinate system established with the terminal 2100. For example, the acceleration sensor 2111 may be configured to detect components of gravity acceleration on the three coordinate axes. The processor 2101 may control, based on a gravity acceleration signal collected by the acceleration sensor 2111, the display screen 2105 to display the UI in a landscape view or a portrait view. The acceleration sensor 2111 may alternatively be configured to collect motion data of a game or a user account.

The gyroscope sensor 2112 may detect a body direction and a rotation angle of the terminal 2100. The gyroscope sensor 2112 may cooperate with the acceleration sensor 2111 to collect a 3D action of the account user on the terminal 2100. The processor 2101 may implement the following functions according to the data acquired by the gyroscope sensor 2112: action sensing (for example, changing the UI according to a tilt operation of the user account), image stabilization at shooting, game control, and inertial navigation.

The pressure sensor 2113 may be disposed at a side frame of the terminal 2100 and/or a lower layer of the display screen 2105. When the pressure sensor 2113 is arranged at the side frame of the terminal 2100, a holding signal of the user account on the terminal 2100 may be detected. The processor 2101 performs left and right hand recognition or a quick operation according to the holding signal collected by the pressure sensor 2113. When the pressure sensor 2113 is arranged on the lower layer of the display screen 2105, the processor 2101 controls, according to a pressure operation of the account user on the display screen 2105, an operable control on the UI. The operable control includes at least one of a button control, a scroll-bar control, an icon control, and a menu control.

The optical sensor 2115 is configured to collect ambient light intensity. In an embodiment, the processor 2101 may control display brightness of the touch display screen 2105 according to the ambient light intensity collected by the optical sensor 2115. Specifically, when the ambient light intensity is relatively high, the display brightness of the display screen 2105 is increased; and when the ambient light intensity is relatively low, the display brightness of the display screen 2105 is decreased. In another embodiment, the processor 2101 may further dynamically adjust a camera parameter of the camera component 2106 according to the ambient light intensity acquired by the optical sensor 2115.

The proximity sensor 2116, alternatively referred to as a distance sensor, is generally arranged on the front panel of the terminal 2100. The proximity sensor 2116 is configured to collect a distance between the user account and a front surface of the terminal 2100. In an embodiment, when the proximity sensor 2116 detects that the distance between the user account and the front surface of the terminal 2100 gradually decreases, the display screen 2105 is controlled by the processor 2101 to switch from a screen-on status to a screen-off status. When the proximity sensor 2116 detects that the distance between the user account and the front surface of the terminal 2100 gradually increases, the touchscreen 2101 is controlled by the display screen 2105 to switch from the screen-off status to the screen-on status.

A person skilled in the art may understand that the structure shown in FIG. 21 does not constitute a limitation on the terminal 2100, and more or fewer components than those shown in the figure may be included, or some components may be combined, or a different component deployment may be used.

The memory further includes one or more programs. The one or more programs are stored in the memory. The one or more programs are configured for performing the social status posting method according to the embodiments of the present disclosure.

The present disclosure further provides a computer device. The computer device includes: a processor and a memory. The memory has at least one instruction, at least one segment of program, and a code set or an instruction set stored therein, and the at least one instruction, the at least one segment of program, and the code set or the instruction set are loaded and executed by the processor to implement the social status posting method according to the foregoing method embodiments.

The present disclosure further provides a computer-readable storage medium. The computer-readable storage medium stores at least one instruction, at least one segment of program, and a code set or an instruction set. The at least one instruction, the at least one segment of program, and the code set or the instruction set are loaded and executed by a processor to implement the social status posting method according to the foregoing method embodiments.

The present disclosure further provides a computer program product or a computer program. The computer program product or the computer program includes computer instructions, the computer instructions being stored in a computer-readable storage medium. A processor of a computer device reads the computer instructions from the computer-readable storage medium, and the processor executes the computer instructions, so that the computer device performs the social status posting method according to the foregoing implementations.

“A plurality of” mentioned in the specification refers to two or more. “And/or” describes an association relationship for describing associated objects and represents that three relationships may exist. For example, A and/or B may represent the following three cases: only A exists, both A and B exist, and only B exists. The character “/” in this specification generally indicates an “or” relationship between the associated objects. A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like. The foregoing descriptions are merely examples of embodiments of the present disclosure, but are not intended to limit the present disclosure. Any modification, equivalent replacement, or improvement made within the spirit and principle of the present disclosure fall within the scope of protection of the present disclosure.

In the present disclosure, before user-related data is collected and during collection of the user-related data, a prompt interface or a pop-up window can be displayed, or voice prompt information can be outputted. The prompt interface, the pop-up window, or the voice prompt information is configured for prompting the user that user-related data is currently being collected. In this way, in the present disclosure, related operations of obtaining the user-related data start to be performed only after a confirmation operation of the user on the prompt interface or the pop-up window is obtained. Otherwise (that is, when no confirmation operation of the user on the prompt interface or the pop-up window is obtained), the related operations of obtaining the user-related data are ended, that is, the user-related data is not to be obtained. In other words, in the present disclosure, all the collected user data is collected with user consent and authorization, and collection, use, and processing of the relevant user data need to comply with relevant laws, regulations, and standards of relevant countries and regions.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments only describe examples of implementations of the present disclosure, which are described specifically and in detail, but cannot be construed as a limitation to the patent scope of the present disclosure. A person of ordinary skill in the art, several transformations and improvements can be made without departing from the idea of the present disclosure. These transformations and improvements belong to the protection scope of the present disclosure. Therefore, the protection scope of the patent of the present disclosure shall be subject to the appended claims.

What is claimed is:

1. A social status posting method, performed by a client running on a computer device and logged in using a first user account, the method comprising:
displaying a first social status posted by the first user account, a posting location of the first social status being a first location; and
displaying, when a positioning location of the client moves from an outside of a geographical area including a first location into the geographical area, a second social status automatically posted by the client, status information of the second social status being determined based on status information of the first social status.

2. The method according to claim 1, wherein the first user account has posted at least two historical social statuses at the first location, the at least two historical social statuses comprise the first social status; and
displaying the second social status automatically posted by the client comprises:
displaying the second social status automatically posted by the client, the second social status being the same as or associated with the first social status, wherein
the first social status is a social status that has a largest number of posts in the at least two historical social statuses.

3. The method according to claim 1, wherein the first user account has posted at least two historical social statuses at the first location, the at least two historical social statuses comprise the first social status; and
displaying the second social status automatically posted by the client comprises:
displaying the second social status automatically posted by the client, the second social status being the same as or associated with the first social status, wherein
the first social status is a social status that has a largest number of posts and that has a posting time closest to a current time in the at least two historical social statuses.

4. The method according to claim 1, wherein a posting time of the first social status is a first time; and
displaying, when the positioning location of the client moves from the outside of the geographical area including the first location into the geographical area, the second social status automatically posted by the client comprises:
displaying, when the positioning location of the client moves from the outside of the geographical area including the first location into the geographical area and the current time and the first time are less than a time threshold, the second social status automatically posted by the client.

5. The method according to claim 1, wherein the client is a client of a first application, the first social status is associated with a second application, and the first application and the second application are different applications; and
displaying, when the positioning location of the client moves from the outside of the geographical area including the first location into the geographical area, the second social status automatically posted by the client comprises:
displaying, when the positioning location of the client moves from the outside of the geographical area including the first location into the geographical area and a running status of the second application is a running status associated with the first social status, the second social status automatically posted by the client,
wherein the status information of the second social status comprises application data of the second application.

6. The method according to claim 1, wherein the client is a client of a first application, the first social status is associated with a second application, and the first application and the second application are different applications; and
displaying, when the positioning location of the client moves from the outside of the geographical area including the first location into the geographical area, the second social status automatically posted by the client comprises:
displaying, when the positioning location of the client moves from the outside of the geographical area including the first location into the geographical area and an automatic generation event of a status is triggered on the second application, the second social status automatically posted by the client, status information of the second social status comprising event information of the automatic generation event,
wherein the status information of the second social status comprises application data of the second application.

7. The method according to claim 1, wherein displaying the first social status posted by the first user account comprises:
displaying a first user interface, the first user interface comprising a first map image, the first map image being configured for marking at least one location at which the first user account has posted a social status, a first identifier being displayed at the first location of the first map image, and the first identifier being configured for marking that the first user account has posted the social status at the first location; and
displaying a first presentation page of the first social status in response to a trigger event for the first identifier, the first presentation page displaying details of the first social status.

8. The method according to claim 7, wherein the first user account has posted at least two social statuses at the first location; the first social status is a first status type; and
displaying the first presentation page of the first social status in response to the trigger event for the first identifier comprises:
displaying a social status list in response to the trigger event for the first identifier, the social status list being configured for displaying at least two status types that have been posted by the first user account in the first location, and the at least two status types comprising the first status type;
displaying, in response to that the first status type is triggered in the social status list, at least one social status that is of the first status type and that has been posted by the first user account at the first location, the at least one social status comprising the first social status; and
displaying, in response to selecting the first social status from the at least one social status, the first presentation page of the first social status.

9. The method according to claim 8, wherein the first identifier comprises a virtual character of the first user account, and the virtual character performs an action corresponding to the first social status at the first location; and
displaying the first user interface comprises:
rendering the virtual character by using a three-dimensional animation rendering engine, to obtain a first rendering result;
rendering the first map image by using a map rendering engine, to obtain a second rendering result; and
displaying the first rendering result at the first location in the second rendering result in an overlapping mode, to obtain the first map image, the first map image comprising the virtual character displayed at the first location.

10. The method according to claim 1, wherein displaying the first social status posted by the first user account comprises:
displaying a second user interface, the second user interface comprising a second map image and a status shortcut browse area, the status shortcut browse area displaying a jump control separately corresponding to at least one social status, and the at least one social status comprising all social statuses posted by the first user account in a preset time period; and
displaying, in response to triggering the first jump control that is located in the status shortcut browse area and that corresponds to the first social status, a third map image, a presentation page of the first social status, and the virtual character of the first user account, the third map image displaying the first location, the presentation page displaying the details of the first social status, the virtual character displaying an action corresponding to the first social status, and the virtual character being displayed at the first location of the third map image.

11. The method according to claim 1, wherein displaying the first social status posted by the first user account comprises:
displaying a third user interface, the third user interface being configured for displaying at least two posting dates when the first user account has posted the social status, the at least two posting dates comprising a first posting date of posting the first social status;
displaying, in response to triggering the first posting date in the third user interface, a status presentation page corresponding to the first posting date, the status presentation page being configured for displaying at least one social status posted by the first user account on the first posting date;
displaying the details of the first social status on the status presentation page when the first user account has only posted the first social status on the first posting date;
displaying a social status selection control on the status presentation page when the first user account has posted at least two social statuses on the first posting date; and displaying the details of the first social status on the status presentation page in response to triggering the social status selection control to select the first social status.

12. The method according to claim 11, wherein the status presentation page further comprises a first footprint display area; and the method further comprises:
displaying a footprint image in the first footprint display area, the footprint image being a footprint image generated on a map image according to a posting location of at least one social status posted by the first user account on the first posting date.

13. The method according to claim 11, wherein the status presentation page further comprises a second footprint display area; and the method further comprises:
displaying a footprint video in the second footprint display area, the footprint video comprising an image in which the virtual character of the first user account moves on the map image,
a moving path of the virtual character on the map image being determined according to a posting time and a posting location of at least one social status posted by the first user account within the first posting date; and performing, by the virtual character at an i^{th} posting location of an i^{th} social status in the at least one social status, an i^{th} action corresponding to the i^{th} social status, and moving, by the virtual character, to an (i+1)^{th} posting location corresponding to an (i+1)^{th} social status after performing the i^{th} action, a posting time of the (i+1)^{th} social status being later than that of the i^{th} social status, and i being a positive integer.

14. The method according to claim 1, further comprising:
displaying a fourth user interface, the fourth user interface comprising a fourth map image, the fourth map image being configured for marking at least one location at which the second user account has posted a social status, and a third identifier of a third social status being displayed at a third location of the fourth map image; and
displaying a third presentation page of the third social status in response to triggering the third identifier, the third presentation page displaying details of the third social status posted by the second user account.

15. The method according to claim 14, further comprising:
displaying a fifth user interface, the fifth user interface comprising a fifth map image, the fifth map image being configured for displaying real-time locations of the first user account and at least one friend account, the at least one friend account being a user account that has a friend relationship with the first user account, and the at least one friend account comprising the second user account; and
displaying the fourth user interface comprises:
displaying the fourth user interface in response to selecting the second user account on the fifth map image, a positioning location of the second user account being located at an image center of the fourth map image.

16. The method according to claim 1, further comprising:
displaying a status posting page, the status posting page comprising a location selection control; and
displaying a location selection page in response to triggering the location selection control, the location selection page displaying at least one candidate location, wherein
when a candidate range comprises a historical posting location at which the first user account has posted the social status, the at least one candidate location comprises the historical posting location, and the candidate range is determined according to the positioning location of the client; the historical posting locations are sorted according to a number of posts of the social status; and
the at least one candidate location comprises the positioning location of the client when the first user account has not posted the social status in the candidate range.

17. The method according to claim 16, wherein the status posting page displays a selected first posting location, wherein
the social posting page further displays prompt information about first check-in when the first user account has not posted the social status at the first posting location; and
when the first user account has posted the social status at the first posting location, the social posting page further displays a number of check-ins completed, the number of check-ins completed comprising a number of the social statuses that have been posted by the first user account at the first posting location.

18. A computer device, comprising:
one or more processors and a memory containing at least one instruction, at least one segment of program, a code set, or an instruction set that, when being executed, causes the one or more processors to perform:
displaying a first social status posted by the first user account, a posting location of the first social status being a first location; and
displaying, when a positioning location of the client moves from an outside of a geographical area including a first location into the geographical area, a second social status automatically posted by the client, status information of the second social status being determined based on status information of the first social status.

19. The device according to claim 18, wherein the first user account has posted at least two historical social statuses at the first location, the at least two historical social statuses comprise the first social status; and the one or more processors are further configured to perform:
displaying the second social status automatically posted by the client, the second social status being same as or associated with the first social status, wherein
the first social status is a social status that has a largest number of posts in the at least two historical social statuses.

20. A non-transitory computer-readable storage medium containing at least one instruction, at least one segment of program, a code set, or an instruction set that, when being executed, causes at least one processor to perform:
displaying a first social status posted by the first user account, a posting location of the first social status being a first location; and
displaying, when a positioning location of the client moves from an outside of a geographical area including a first location into the geographical area, a second social status automatically posted by the client, status information of the second social status being determined based on status information of the first social status.
